(19) United States
(12) Patent Application Publication
(10) Pub. No.: US 2004/0205505 A1
(43) Pub. Date: Oct. 14, 2004

(54) Preprocessing and preloading digital display pages in multiple page digital data files

(76) Inventors: A. Marie Vans, Shefar-am (IL); Carl H. Staelin, Haifa (IL); Darryl Greig, Haifa (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/041,923

(22) Filed: Jan. 8, 2002

(51) Int. Cl. G06F 15/00

(52) U.S. Cl. 715/501.1; 715/526

(57) ABSTRACT

A display page processing device includes at least one input device, a processor, and a memory. The memory includes a display pages storage area, a most-recently-visited pages storage area, a most-likely-to-be-visited pages storage area, and a number-of-pages-to-be-loaded variable storage area. The processor uses a most-recently-visited pages information from the most-recently-visited pages storage area, a most-likely-to-be-visited pages information from the most-likely-to-be-visited pages storage area, and a number-of-pages-to-be-loaded variable from the number-of-pages-to-be-loaded variable storage area in order to fetch and/or store two or more display pages to the display pages storage area.

### FIELD OF THE INVENTION

The present invention relates generally to display of digital data, and more particularly to the display of multiple pages of digital data.

### BACKGROUND OF THE INVENTION

Computer systems may display many types of information on a screen or other display device. The information may include text, graphics, etc. The information is generally displayed on a cathode ray tube (CRT) or other display and is generally loaded from a main memory to a display page memory. The contents of the display page memory are sent to the display device.

Due to the large amount of work and other activities conducted on computers, there is a large need for efficient and easy to use display devices. Computer users want fast loading of display page information and do not want to wait for information to load.

The display page loading process may include an image decompression process, wherein the information is stored in the main memory in a compressed state in order to conserve memory. Consequently, the information must be decompressed for display (this applies only to non-text information). Another part of the display page loading process may be the setting of the image resolution. For example, the information may be stored as an image of 300 dots per inch (dpi) resolution, but the user may desire the image to be displayed at another resolution, depending on the display device, the purpose of the display, the desired fineness of detail, etc.

A typical personal computer may include from about one megabyte (Mb) of random access memory (RAM) to about 256 Mb of RAM. Each display page, when loaded as an image, may require up to about 2 Mb of space in RAM. However, a large part of the available RAM may be used by running applications, such as a word processor, web browser, screen saver, etc.

In the prior art, image data is loaded and displayed one page at a time. This is typically done in order to avoid memory size limitations. Memory size in a majority of computers is limited by the practical constraint of cost. Users can increase their memory size in order to decrease image-loading times, but most users do not have an unlimited budget for memory. In addition, the user may not have the authority to choose a large memory size. The prior art therefore typically loads only a single display page at a time in order to avoid excessive memory usage. As a result, when the user selects another page to be viewed, this next page must first be decompressed and rescaled before it can be loaded. This has the benefit of being a simple approach.

However, the practical result of the prior art approach is a time delay between the selection of a new page and the corresponding display of the page. The delay is the result of the processing that must be done on the raw image data, i.e., the decompression and resealing of the image data. The user may have to wait up to 30 seconds for a new page to load, depending on the document, the software application loading the document, and the computer running the software application. This delay impacts user efficiency. The delay may result in frustration, loss of attention span, etc.

Therefore, there remains a need in the art for improvements in the display of digital data.

### SUMMARY OF THE INVENTION

A display page processing device comprises at least one input device, a processor, and a memory. The memory includes a display pages storage area, a most-recently-visited pages storage area, a most-likely-to-be-visited pages storage area, and a number-of-pages-to-be-loaded variable storage area. The processor uses a most-recently-visited pages information from the most-recently-visited pages storage area, a most-likely-to-be-visited pages information from the most-likely-to-be-visited pages storage area, and the number to-be-loaded variable storage area in order to fetch and/or store two or more display pages to the display pages storage area.

### BRIEF DESCRIPTION OF THE DRAWINGS

FIG. 1 is a schematic of a display page processing device according to one embodiment of the invention;

FIG. 2 is a flowchart of a computer-implemented page display method according to another embodiment of the invention; and

FIG. 3 is a flowchart of a computer-implemented page display method according to yet another embodiment of the invention.

### DETAILED DESCRIPTION

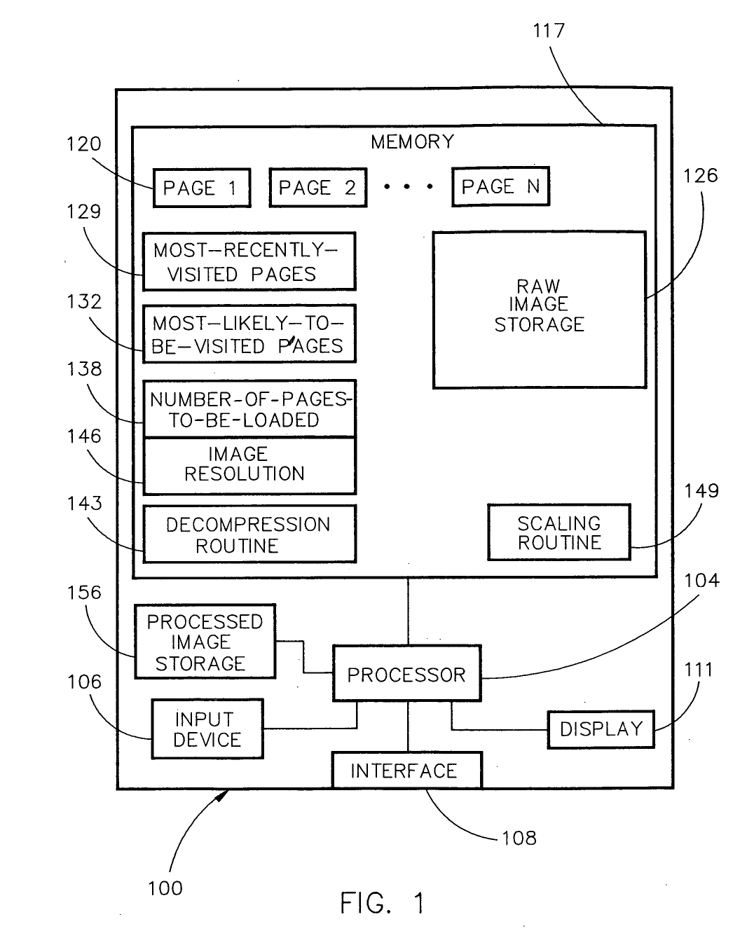

FIG. 1 is a schematic of a display page processing device 100 according to one embodiment of the invention. The display page processing device 100 may be any type of electronic device capable of loading multiple page digital display data files. The display page processing device 100 may include a processor 104, at least one input device 106, a communication interface 108, a display 111, a memory 117, and an optional processed image storage area 156.

The processor 104 may be any type of general purpose processor. The processor 104 executes a control routine contained in the memory 117. In addition, the processor 104 receives inputs and controls the generation and display of selected digital data files.

The one or more input devices 106 may be any type of input device, including a keyboard, a mouse or other pointing device, a touch screen, etc.

The display 111 may be any type of electronic display device, including a cathode ray tube (CRT), a liquid crystal display (LCD), etc.

The communication interface 108 communicates with the processor 104 and may be any type of interface that allows the display page processing device 100 to communicate with other computer devices. For example, the interface 108 may be a network card and therefore the display page processing device 100 may be linked to a computer network. Alternatively, the interface 108 may be a modem that allows the display page processing device 100 to connect to other computers via a telephone line. In another alternative, the interface 108 may be a wireless transceiver that allows the display page processing device 100 to communicate with other wireless computer devices.

The memory 117 may be any type of solid state memory. The memory may include, among other things, display pages storage area 120, a raw image storage area 126, a most-recently-visited pages storage area 129, a most-likely-to-be-visited pages storage area 132, a number-of-pages-to-be-loaded variable storage area 138, a decompression routine storage area 143, an image resolution variable storage area 146, and a scaling routine storage area 149. In addition, the memory 117 may store other software or firmware to be executed by the processor 104.

The display pages storage area 120 may store two or more decompressed and scaled images that are ready for display. The display pages storage area 120 therefore comprises a display page cache, wherein new pages may be fetched, processed, and loaded in advance.

The raw image storage area 126 may hold one or more raw images, including uncompressed images and images that have been compressed for storage. The raw images may be any type of digital display data files, such as scanned documents, for example. The raw image storage area 126 may be part of a random access memory (RAM) of the display page processing device 100, or alternatively may be located on another memory, such as a hard disk drive, etc. In another alternative, the raw image data may be obtained from an external device via the communication interface 108.

The most-recently-visited pages storage area 129 stores information that designates two or more recently visited display pages. For example, the most-recently-visited pages storage area 129 may store page numbers or memory addresses of recently visited pages. Some or all of these most-recently-visited pages may be stored in the processed image storage area 156.

The most-likely-to-be-visited pages storage area 132 stores information about which pages of a current document or file the user will most likely visit. Therefore, this information is a prediction of which pages the user will visit. The most-likely-to-be-visited pages storage area 132 may be set to a default value that may be changed by the user.

The number-of-pages-to-be-loaded variable storage area 138 is the variable N, and controls how many pages are loaded into the display pages storage area 120. The number-of-pages-to-be-loaded variable storage area 138 may be user-settable and may be varied according to the amount of available memory in the memory 117, among other things. Therefore, this variable may accommodate older computers, which have less available memory.

The decompression routine storage area 143 is a routine or algorithm for decompressing compressed images. The compressed images may be obtained from the raw image storage area 126 or may be images obtained from other computer devices. The decompression routine may be any type of digital image compression/decompression known in the art.

The image resolution variable storage area 146 controls the image resolution of each display page of a displayed digital data file. The image resolution variable therefore may be set by the user to any desired image resolution.

The scaling routine storage area 149 may be any type of routine or algorithm for setting or resealing an image resolution of an image to be displayed. The scaling routine storage area 149 therefore may be used by the processor 104 in order to set the image resolution. The user may select the image resolution using the one or more input devices 106, and will preferably be an image resolution that can be accommodated by the display 111.

The processed image storage area 156 may be used to store decompressed, rescaled images that have already been displayed but have been bumped from the display pages storage area 120. Therefore, in the event one of these previously viewed images is recalled by the user to be displayed again, the particular previously viewed image will be ready to be displayed. Although the particular previously viewed image will take longer to load than an image in the display pages storage area 120, it will still load significantly faster than a display page from the raw image storage area 126 that must be decompressed, rescaled, etc. The processed image storage area 156 may be any type of memory, but preferably is a long-term memory, such as a computer hard disk drive, for example.

In operation, when a multi-page digital data file is to be loaded, the processor 104 uses the most-recently-visited pages information and the most-likely-to-be-visited pages information to load N display pages into the display pages storage area 120, as determined by the value in the number-of-pages-to-be-loaded variable storage area 138. During the loading process, a first page is decompressed and rescaled to a desired image resolution. After that, subsequent pages are processed and loaded until all N pages are loaded into the display pages storage area 120.

Although the user will still have to wait for the first page to be processed and loaded, the user will most likely be viewing the first page while the subsequent pages are being processed and stored. Therefore, the user will enjoy a reduced time lag between pages. The subsequent loading of additional pages significantly improves the response time when the user goes to another page, if that page is one of the loaded display pages in the display pages storage area 120. If the user instead selects a non-loaded page, the user will still experience some processing and loading time delays. However, due to the use of the most-recently-visited pages information and the most-likely-to-be-visited pages information, the likelihood of having to process new image data is greatly reduced and the user will most likely enjoy a much faster display page display.

It should be understood that in one embodiment the display page processing device 100 may perform caching, wherein previously viewed pages may be retained in either the display pages storage area 120 or in the processed image storage area 156. Alternatively, in another embodiment the display page processing device 100 may perform pre-fetching, wherein two or more display pages are obtained and processed before they are needed. In yet another embodiment, the display page processing device 100 may perform both pre-fetching and caching.

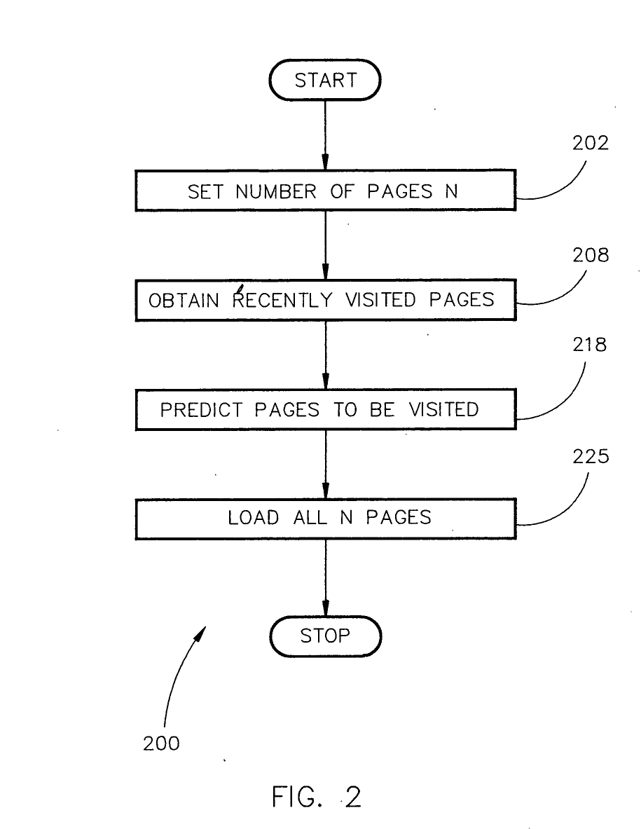

FIG. 2 is a flowchart 200 of a computer-implemented page display method according to another embodiment of the invention. In step 202, the total number of pages to be preprocessed and preloaded is set (i.e., the variable N). The number of pages N may be chosen according to the memory availability and the processing capability of the display page processing device 100.

In step 208, the display page processing device 100 obtains most-recently-visited pages information. The most-recently-visited pages information shows which pages the user previously visited during a current viewing session. In one embodiment, the recently visited pages information may contain only information about pages visited during the current viewing session and may not contain information from previous viewing sessions of the digital data file. The most-recently-visited pages information is employed as part of the pre-loading calculation because it may serve as a reasonable predictor of future behavior of the user.

In step 218, the most-likely-to-be-visited pages are predicted. This prediction is done by an algorithm within the display page processing device 100 that predicts the most-likely-to-be-visited pages based on a statistical analysis of user viewing habits (i.e., for a certain document, the user is likely to go sequentially from the first page to the last page, for example). The assumption behind the most-likely-to-be-visited pages prediction is that the user will initially go through display pages in sequence. Once the user has viewed a particular display page, it is more likely the user will return to that page. This prediction information is stored in the most-likely-to-be-visited pages storage area 132.

Because the prediction is preferably static, the pages visited during a current viewing session may not be included in the prediction (i.e., current changes to the most-recently-visited pages information is not used to load pages; at least until the next opening of the digital data file). Therefore, the prediction may be based solely on the current viewing session.

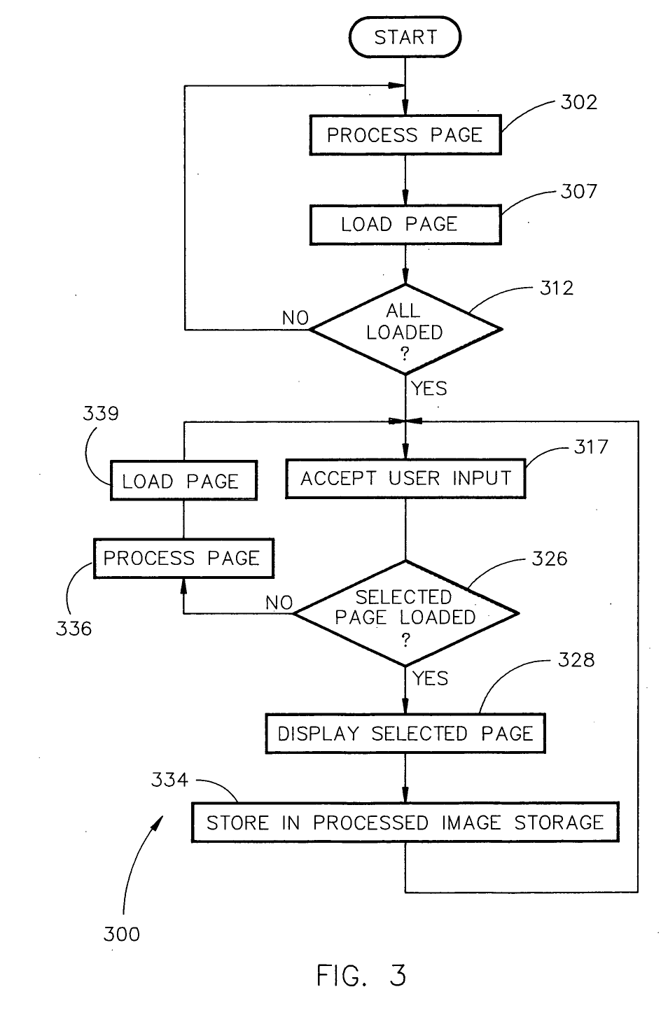

In step 225, all N pages are loaded into the display pages storage area 120. The loading step is expanded upon in FIG. 3 and the discussion below.

FIG. 3 is a flowchart 300 of a computer-implemented page display method according to yet another embodiment of the invention. In step 302, raw display page data is obtained and processed. The processing may include decompression and display resolution resealing operations. These processing steps are the main cause of delay between the display of pages in the prior art.

The raw data may be obtained from a local memory or may be obtained from another computer. For example, the raw image data may be stored on a shared drive, wherein different users can access the raw image data. Alternatively, it may be stored on a network drive, such as a computer network application, or may be obtained from a client-server system.

In step 307, the processed image data is loaded into the display pages storage area 120.

In step 312, if not all pages are loaded, then the method branches back to step 302 for further display page processing and loading. Otherwise, the method proceeds to step 317.

In step 317, the process waits for a user input to be accepted. At this point, all initial processing and loading has been performed. The method now waits for a user input, wherein the user input may designate a new page to be viewed. It should be noted that the user input may occur at any time and the input may occur significantly after the image processing and loading.

In step 326, it is determined whether a user input designates a loaded and ready-to-display page or a raw (i.e., a non-processed and non-loaded) display page. If the user input designates a raw display page, then the method branches to step 336; otherwise, it proceeds onto step 328.

In step 328, because the user input designated a processed and loaded display page, the display page may be immediately displayed. In addition, in this step the current page number may be added to the most-recently-visited pages storage area 129 for future use, such as during the current viewing session.

In optional step 334, a page bumped from the display pages storage area 120 (i.e., by the newly processed and loaded raw display page) may be stored in the processed image storage area 156. The bumped page may be stored in a decompressed and scaled state, and therefore may be quickly reloaded and displayed if needed.

In step 336, because the designated page has not been processed, the desired page is processed as previously discussed in step 302.

In step 339, the designated display page is loaded into the display pages storage area 120 as previously discussed in step 307, and is then displayed to the user. As a result, a time delay will be experienced by the user. However, due to the use of the most-likely-to-be-visited pages information and the most-recently-visited pages information, there is a high probability that the designated page has already been processed and loaded and is ready for display.

The invention differs from the prior art in that the invention preprocesses multiple display pages of a digital data file before they are selected by the user. Moreover, the invention preloads multiple display pages before they are selected by the user. The preprocessing and preloading according to the invention are based on the most-recently-visited pages information and on the most-likely-to-be-visited pages information. Therefore, the invention more efficiently preprocesses and preloads display pages by tracking pages previously visited by the user. Furthermore, the invention more efficiently preprocesses and preloads display pages by predicting pages likely to be selected by the user.

The preprocessing and preloading of digital display pages according to the invention provides several benefits. The invention provides a faster loading of display pages. The invention provides less waiting times for image loading and therefore reduces user delay and frustration and minimizes distraction to the user.

1. A display page processing device, comprising:
at least one input device capable of accepting a user input;
a processor communicating with said at least one input device and capable of communicating with a display device; and
a memory including a display pages storage area, a most-recently-visited pages storage area, a most-likely-to-be-visited pages storage area, and a number-of-pages-to-be-loaded variable storage area;
wherein said processor uses said most-recently-visited pages storage area, said most-likely-to-be-visited pages storage area, and said number-of-pages-to-be-loaded variable storage area in order to fetch and/or store two or more display pages to said display pages storage area in response to a single user input without waiting for a user to select additional pages to view on said display device.

2. The device of claim 1, wherein said display page processing device further includes a processed image storage and wherein a previously processed and viewed display page is stored in said processed image storage after it is bumped from said display pages storage area.

3. The device of claim 1, wherein said memory further includes a raw image storage area and said memory and said processor are both located in a common display page processing device.

4. The device of claim 1, wherein said display page processing device further includes a communication interface and wherein said display page processing device is capable of obtaining raw image data using said communication interface.

5. The device of claim 1, wherein said memory further includes an image decompression routine storage area and wherein said processor uses an image decompression routine to decompress a display page before loading said display page to said display pages storage area.

6. The device of claim 1, wherein said memory further includes a user-settable predetermined image resolution variable storage area and an image scaling routine storage area, and wherein said processor uses an image scaling routine to set an image resolution of a display page to a predetermined image resolution variable.

7. The device of claim 1, wherein said most-recently-visited pages storage area stores a predetermined number of recently visited display page numbers.

8. The device of claim 1, wherein a page number of a currently viewed page is stored to said most-recently-visited pages storage area.

9. The device of claim 1, wherein said most-likely-to-be-visited pages storage area stores a predetermined number of predicted display page numbers.

10. The device of claim 1, wherein said number-of-pages-to-be-loaded variable storage area is user-settable.

11. The device of claim 1, wherein said most-recently-visited pages storage area stores a user-defined number of recently visited display pages.

12. A computer-implemented page display method, comprising the steps of:
obtaining a predetermined number-of-pages-to-be-loaded variable;
obtaining stored most-recently-visited pages information;
obtaining stored most-likely-to-be-visited pages information;
pre-fetching a predetermined number of display pages as set by said predetermined number-of-pages-to-be-loaded variable, with said predetermined number of display pages being fetched based on said most-recently-visited pages information and,on said most-likely-to-be-visited pages information;
decompressing said predetermined number of display pages; and
scaling said predetermined number of display pages to a predetermined image resolution.

13. The method of claim 12, wherein the pre-fetching step further comprises fetching said predetermined number of display pages from a raw image storage area.

14. The method of claim 12, further comprising the preliminary step of storing a predetermined number of recently visited display page numbers to said most-recently-visited pages information.

15. The method of claim 12, further comprising the step of storing a page number of a currently viewed page to said most-recently-visited pages information.

16. The method of claim 12, further comprising the preliminary step of storing a predetermined number of predicted display page numbers to said most-likely-to-be-visited pages information.

17. The method of claim 12, further comprising the step of accepting a user input that selects said predetermined image resolution.

18. The method of claim 12, further comprising the step of accepting a user input that sets said predetermined number-of-pages-to-be-loaded variable.

19. The method of claim 12, further comprising the steps of:
accepting a user input that designates a next display page;
comparing said next display page to said predetermined number of display pages; and
displaying said next display page if said next display page is in said predetermined number of display pages.

20. The method of claim 12, further comprising the step of storing said predetermined number of display pages to a display pages storage area after the decompressing and scaling steps.

21. A computer-implemented page display method, comprising the steps of:
obtaining a predetermined number-of-pages-to-be-loaded variable;
obtaining stored most-recently-visited pages information;
obtaining stored most-likely-to-be-visited pages information;
obtaining a predetermined number of display pages as set by said predetermined number-of-pages-to-be-loaded variable, with said predetermined number of display pages being fetched based on said most-recently-visited pages information and on said most-likely- to-be-visited pages information;
decompressing said predetermined number of display pages;
scaling said predetermined number of display pages to a predetermined image resolution; and
storing said predetermined number of display pages to a display pages storage area.

22. The method of claim 21, further comprising the preliminary step of storing a predetermined number of recently visited display page numbers to said most- recently-visited pages information.

23. The method of claim 21, further comprising the step of storing a page number of a currently viewed page to said most-recently-visited pages information.

24. The method of claim 21, further comprising the preliminary step of storing a predetermined number of predicted display page numbers to said most-likely-to-be- visited pages information.

25. The method of claim 21, further comprising the step of accepting a user input that selects said predetermined image resolution.

26. The method of claim 21, further comprising the step of accepting a user input that sets said predetermined number-of-pages-to-be-loaded variable.

27. (Original) The method of claim 21, further comprising the steps of:
accepting a user input that designates a next display page;
comparing said next display page to said predetermined number of display pages; and
displaying said next display page if said next display page is in said predetermined number of display pages.

28. The method of claim 21, further comprising the step of storing a previously processed and viewed display page in a processed image storage area after said previously processed and viewed display page is bumped from said display pages storage area.

29. The method of claim 21, wherein the step of obtaining said predetermined number of display pages further comprises pre-fetching said predetermined number of display pages from a raw image storage area.

30. A computer-implemented page display method, comprising the steps of:
obtaining a predetermined number-of-pages-to-be-loaded variable;
obtaining stored most-recently-visited pages information;
obtaining stored most-likely-to-be-visited pages information;
pre-fetching a predetermined number of display pages as set by said predetermined number-of-pages-to-be-loaded information, with said predetermined number of display pages being fetched based on said most-recently-visited pages information and on said most-likely-to-be-visited pages information;
decompressing said predetermined number of display pages;
scaling said predetermined number of display pages to a predetermined image resolution; and
storing said predetermined number of display pages to a display pages storage area.

31. The method of claim 30, wherein the pre-fetching step further comprises fetching said predetermined number of display pages from a raw image storage area.

32. The method of claim 30, further comprising the preliminary step of storing a predetermined number of recently visited display page numbers to said most-recently-visited pages information.

33. The method of claim 30, further comprising the step of storing a page number of a currently viewed page to said most-recently-visited pages information.

34. The method of claim 30, further comprising the preliminary step of storing a predetermined number of predicted display page numbers to said most-likely-to-be-visited pages information.

35. The method of claim 30, further comprising the step of accepting a user input that selects said predetermined image resolution.

36. The method of claim 30, further comprising the step of accepting a user input that sets said predetermined number-of-pages-to-be-loaded variable.

37. The method of claim 30, further comprising the steps of:
accepting a user input that designates a next display page;
comparing said next display page to said predetermined number of display pages; and
displaying said next display page if said next display page is in said predetermined number of display pages.

38. The method of claim 30, further comprising the step of storing a previously processed and viewed display page in a processed image storage area after said previously processed and viewed display page is bumped from said display pages storage area.
